(19) United States
(12) Patent Application Publication
(10) Pub. No.: US 2022/0276372 A1
(43) Pub. Date: Sep. 1, 2022

(54) CONTROL DEVICE AND PROGRAM

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/618,201

(22) PCT Filed: Apr. 17, 2020
(86) PCT No.: PCT/JP2020/016819

§ 371 Date: Dec. 10, 2021

(30) Foreign Application Priority Data
Aug. 9, 2019 (JP) 2019-147216

(51) Int. Cl. G01S 13/76; H04B 1/7163

(52) U.S. Cl. CPC G01S 13/76; H04B 1/71632; H04B 2201/71634; B60R 25/245

(57) ABSTRACT

There is provided a mechanism that can reduce a process amount required to measure a distance.

There is provided a control device that includes a control section configured to control a distance measurement process of calculating a distance measurement value that is a measurement value of a distance between communication devices, and in which the control section calculates the distance measurement value based on at least time information that is information related to a time taken for transmission and reception of a signal between the communication devices.

### TECHNICAL FIELD

The present invention relates to a control device and a program.

### BACKGROUND ART

In recent years, a technology that measures a distance between devices according to a result of transmission and reception of signals between the devices has been developed. For example, following Patent Literature 1 discloses a technology that measures a distance between in-vehicle equipment and a portable device based on a rotation amount of phases of signals transmitted and received between the in-vehicle equipment and the portable device.

### CITATION LIST

### Patent Literature

Patent Literature 1: JP 2018-48821A

### SUMMARY OF INVENTION

### Technical Problem

By the way, when a distance measurement process based on a rotation amount of phases of signals to be transmitted and received as described above is performed, a process amount required to measure a distance becomes great.

Hence, the present invention has been made in light of the above problem, and an object of the present invention is to provide a mechanism that can reduce a process amount required to measure a distance.

### Solution to Problem

To solve the above problem, one aspect of the present invention provides a control device that includes a control section configured to control a distance measurement process of calculating a distance measurement value that is a measurement value of a distance between communication devices, and in which the control section calculates the distance measurement value based on at least time information that is information related to a time taken for transmission and reception of a signal between the communication devices.

Furthermore, to solve the above problem, another aspect of the present invention provides a program that causes a computer to function as a control section configured to control a distance measurement process of calculating a distance measurement value that is a measurement value of a distance between communication devices, and that causes the control section to calculate the distance measurement value based on at least time information that is information related to a time taken for transmission and reception of a signal between the communication devices.

### Advantageous Effects of Invention

As described above, the present invention provides a mechanism that can reduce a process amount required to measure a distance.

### BRIEF DESCRIPTION OF DRAWINGS

FIG. 1 is a configuration example of a system according to an embodiment of the present invention.

FIG. 2 is a sequence diagram illustrating a flow of a distance measurement process executed by the system according to the embodiment.

### DESCRIPTION OF EMBODIMENTS

A preferred embodiment of the present invention will be described in detail below with reference to the appended drawings. Note that components employing substantially identical functional configurations will be assigned the same reference numerals, and overlapping description thereof will be omitted in the description and the drawings.

### 1. Embodiment

### 1.1. Configuration Example

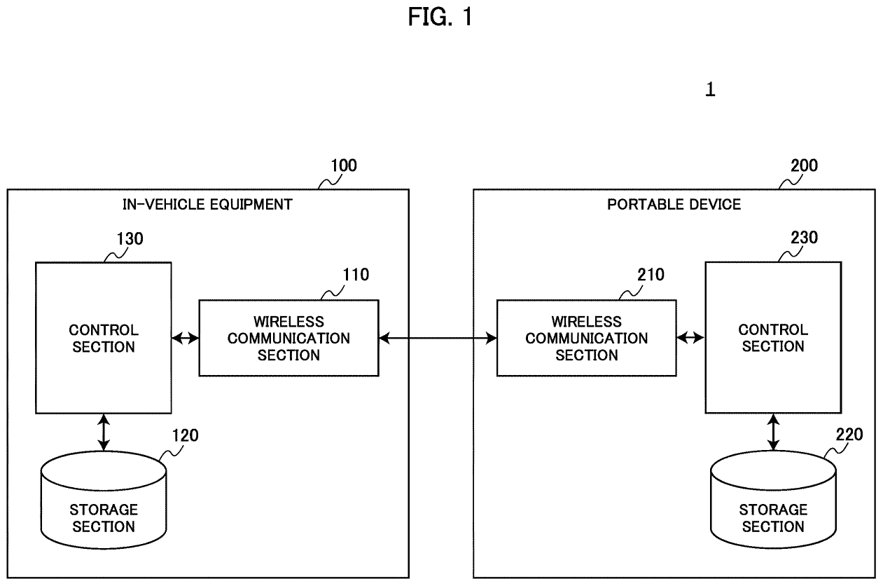

FIG. 1 is a diagram illustrating the configuration example of a system 1 according to the embodiment of the present invention. As illustrated in FIG. 1, the system 1 according to the present embodiment may be configured to include in-vehicle equipment 100 and a portable device 200. The in-vehicle equipment 100 and the portable device 200 are examples of a control device and a communication device according to the present invention. At least one of the in-vehicle equipment 100 and the portable device 200 has a function of controlling a distance measurement process of calculating a distance measurement value that is a measurement value of a distance between the in-vehicle equipment 100 and the portable device 200.

(In-Vehicle Equipment 100)

The in-vehicle equipment 100 according to the present embodiment is mounted on a vehicle that a user gets on (e.g., a vehicle owned by the user or a vehicle that is temporarily lent to the user). The in-vehicle equipment 100 may have a function of controlling unlocking of a door or starting of an engine of the vehicle based on, for example, a result of an authentication process via wireless communication with the portable device 200 carried by the user. According to this function, by approaching the vehicle carrying the portable device 200, the user can access a vehicle interior without performing an additional unlocking operation, and starts the vehicle without inserting a physical key in the vehicle.

Furthermore, in addition to, for example, the above authentication process, the in-vehicle equipment 100 may calculate a distance measurement value between the in-vehicle equipment 100 and the portable device 200, and control unlocking of the door or starting of the engine based on the distance measurement value. More specifically, only when the in-vehicle equipment 100 and the portable device 200 succeed in the authentication process, and the distance between the in-vehicle equipment 100 and the portable device 200 is a specified distance or less, the in-vehicle equipment 100 may permit unlocking of the door or starting of the engine. According to this function, it is possible to prevent falsification of an authentication target device (e.g., portable device 200) such as relay attack, and falsification of a distance, and effectively enhance authentication accuracy.

As illustrated in FIG. 1, the in-vehicle equipment 100 according to the present embodiment includes a wireless communication section 110, a storage section 120, and a control section 130.

The wireless communication section 110 according to the present embodiment has a function of performing communication conforming to specified wireless communication standards for the portable device 200. As the above wireless communication standards, Ultra-Wide Band (UWB) wireless communication standards may be used. For example, the in-vehicle equipment 100 may measure a distance measurement value between the in-vehicle equipment 100 and the portable device 200 by transmitting and receiving signals conforming to the ultra-wide band wireless communication standards to and from the portable device 200.

Furthermore, the wireless communication section 110 may have a function of performing wireless communication that uses, for example, an Ultra-High Frequency (UHF) or a Low Frequency (LF). In this case, the in-vehicle equipment 100 can perform authentication with respect to the portable device 200 by a challenge response method that uses the LF/UHF.

The storage section 120 according to the present embodiment stores various pieces of information for an operation of the in-vehicle equipment 100. The storage section 120 stores, for example, programs for the operation of the in-vehicle equipment 100, identification information such as an Identifier (ID), key information such as a password, an authentication algorithm, and a below-described specified value. The storage section 120 is configured to include, for example, a storage medium such as a flash memory, and a processing device that executes recording and playback of the storage medium.

The control section 130 according to the present embodiment controls a distance measurement process of calculating a distance measurement value that is a measurement value of a distance between communication devices (e.g., the in-vehicle equipment 100 and the portable device 200). One of features of the control section 130 according to the present embodiment is that the control section 130 calculates the above distance measurement value based on at least time information that is information related to a time taken for transmission and reception of signals between the communication devices. Details of the distance measurement process according to the present embodiment will be described later separately. The control section 130 includes, for example, an electronic circuit such as a Central Processing Unit (CPU) and a microprocessor. Furthermore, the control section 130 may have a function of controlling the authentication process with respect to the portable device 200.

(Portable Device 200)

The portable device 200 according to the present embodiment is a communication device carried by the user of the vehicle on which the in-vehicle equipment 100 is mounted. The portable device 200 according to the present embodiment may be, for example, an electronic key, a smartphone, and a wearable terminal. As illustrated in FIG. 1, the portable device 200 according to the present embodiment includes a wireless communication section 210, a storage section 220, and a control section 230.

The wireless communication section 210 according to the present embodiment has a function of performing wireless communication with the in-vehicle equipment 100. The wireless communication section 210 performs wireless communication that conforms to the UWB or wireless communication that uses the UHF/LF under, for example, control of the control section 230.

The storage section 220 according to the present embodiment stores various pieces of information for an operation of the portable device 200. The storage section 220 stores, for example, programs for the operation of the portable device 200, identification information such as an ID, key information such as a password, an authentication algorithm, and a below-described specified value. The storage section 220 is configured to include, for example, a storage medium such as a flash memory, and a processing device that executes recording and playback of the storage medium.

The control section 230 according to the present embodiment controls a distance measurement process of calculating a distance measurement value that is a measurement value of a distance between communication devices (e.g., the in-vehicle equipment 100 and the portable device 200). One of features of the control section 230 according to the present embodiment is that the control section 230 calculates the above distance measurement value based on at least time information that is information related to a time taken for transmission and reception of signals between the communication devices. The control section 230 includes, for example, an electronic circuit such as a CPU and a microprocessor.

The configuration example of the system 1 according to the present embodiment has been described above. Note that the configuration described with reference to FIG. 1 is a mere example, and the configuration of the system 1 according to the present embodiment is not limited to this example. The configuration of the system 1 according to the present embodiment can be flexibly altered according to a specification and an operation.

### 1.2. Details

Next, the distance measurement process realized by the system 1 according to the present embodiment will be described in detail. As described above, in recent years, a technology that measures a distance between devices according to a result of transmission and reception of signals between the devices has been developed. However, as disclosed in, for example, Patent Literature 1, when a distance is measured based on a rotation amount of phases of signals to be transmitted and received between the devices, a process amount required to measure the distance tends to become great.

Hence, one of the features of the control device according to the present embodiment is that the control device calculates a distance between the communication devices based on at least time information that is information related to transmission and reception of signals between the communication devices. According to this feature, it is possible to effectively reduce the process amount required to measure the distance between the communication devices, and realize an effective distance measurement process.

Furthermore, the control device according to the present embodiment may execute as the above distance measurement process a process including at least transmitting a first signal from one communication device to an other communication device, receiving the first signal at the above other communication device, and calculating a distance measurement value by using a time length taken for transmission and reception of the first signal as time information.

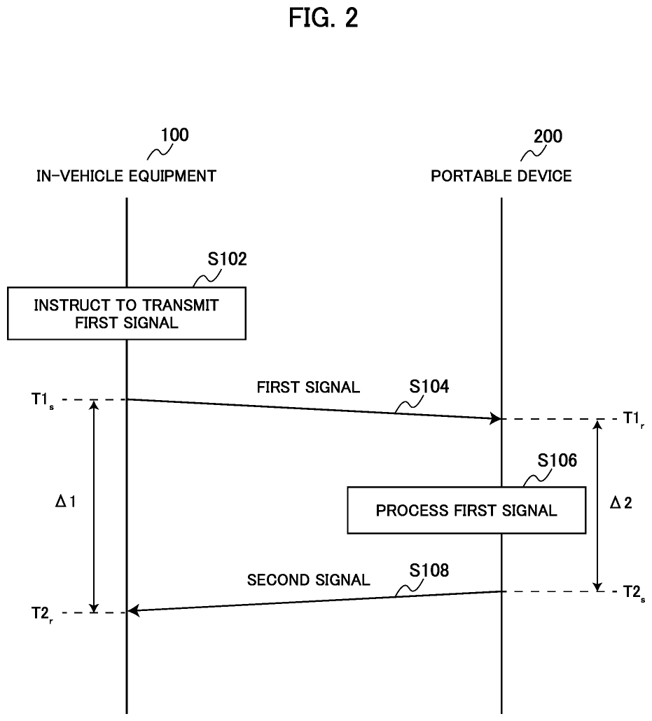

FIG. 2 is a sequence diagram illustrating a flow of the distance measurement process executed by the system 1 according to the present embodiment. Note that FIG. 2 illustrates an example of a case where the in-vehicle equipment 100 corresponds to the above one communication device, and the portable device 200 corresponds to the above other communication device.

In this case, as illustrated in FIG. 2, the control section 130 of the in-vehicle equipment 100 first outputs to the wireless communication section 110 an instruction to start transmission of the first signal (step S102). Subsequently, the wireless communication section 110 transmits the first signal according to the instruction output in step S102 (S104).

Next, when the wireless communication section 210 of the portable device 200 receives the first signal transmitted in step S104, the control section 230 of the portable device 200 processes the first signal (S106). The process may include, for example, a process of identifying the in-vehicle equipment 100. When finishing processing the first signal in step S106, the control section 230 outputs to the wireless communication section 210 an instruction to start transmission of the second signal, and the wireless communication section 210 transmits the second signal based on the instruction (S108).

When the wireless communication section 110 of the in-vehicle equipment 100 receives the second signal transmitted in step S108, the control section 130 of the in-vehicle equipment 100 calculates the distance measurement value by using at least a time length taken for transmission and reception of the first signal as the time information.

For example, in step S104, a timing at which the wireless communication section 110 transmits the first signal is T1ₛ, and a timing at which the wireless communication section 210 receives the first signal is T1ᵣ, and, in step S108, a timing at which the wireless communication section 210 transmits the second signal is T2ₛ, and a timing at which the wireless communication section 110 receives the second signal is T2ᵣ.

In this case, a time length ΔT1 from T1ₛ to T2ᵣ corresponds to a time length taken for transmission and reception of the first signal and the second signal, and a time length ΔT2 from T1ᵣ to T2s corresponds to a time length taken until the portable device 200 transmits the second signal as the response to the first signal after receiving the first signal, so that it is possible to calculate a propagation time taken for transmission and reception of the first signal and the second signal by subtracting ΔT2 from ΔT1. Furthermore, it is possible to obtain a time length required for one of transmission and reception of the first signal and transmission and reception of the second signal by dividing by 2 a time length obtained by subtracting ΔT2 from ΔT1.

Furthermore, in a case where the first signal and the second signal are signals that conform to the ultra-wide band wireless communication standards, propagation speeds of both of the signals are substantially equal to the light speed, so that it is possible to calculate the distance measurement value between the in-vehicle equipment 100 and the portable device 200 by multiplying (ΔT1−ΔT2)/2 with the light speed.

Thus, the system 1 according to the present embodiment can realize the distance measurement process of a reduced process amount by using the time information such as ΔT1 and ΔT2 that are the information related to transmission and reception of signals between the communication devices.

In addition, either the control section 130 of the in-vehicle equipment 100 and the control section 230 of the portable device 200 may calculate the distance measurement value. When, for example, the portable device 200 includes, in the second signal, time information that indicates a time length associated with ΔT2 to transmit, the control section 130 of the in-vehicle equipment 100 can calculate ΔT1 and the distance measurement value by obtaining the time information that indicates T1ₛ and T2ᵣ from the wireless communication section 110.

On the other hand, when the in-vehicle equipment 100 transmits time information that indicates a time length associated with ΔT1, the control section 230 of the portable device 200 can calculate ΔT2 and the distance measurement value by obtaining the time information that indicates T1ᵣ and T2ₛ from the wireless communication section 210.

Furthermore, the system 1 according to the present embodiment may not necessarily transmit and receive the second signal. For example, the wireless communication section 110 of the in-vehicle equipment 100 may include, in the first signal, the time information that indicates T1ₛ that is a transmission timing of the first signal to transmit to the portable device 200 or transmit the time information and the first signal together to the portable device 200. In this case, the control section 230 of the portable device 200 can calculate the propagation time of the first signal and the distance measurement value based on the received information that indicates T1ₛ and the time information that is recorded by the wireless communication section 210 and indicates T1ᵣ. On the contrary, when the wireless communication section 210 of the portable device 200 transmits the time information that indicates T1ᵣ that is the reception timing of the first signal to the in-vehicle equipment 100, the control section 130 of the in-vehicle equipment 100 can calculate the propagation time of the first signal and the distance measurement value based on the time information that is recorded by the wireless communication section 110 and indicates T1ₛ, and the received time information that indicates T1ᵣ.

Furthermore, the system 1 according to the present embodiment may cause the one communication device to perform first transmission to the other communication device, and calculate the distance measurement value by using as the time information a specified value specified in advance in addition to the time length taken for transmission and reception of the first signal. Furthermore, the above specified value may be shared between the communication devices in advance.

The above specified value may specify, for example, a time length taken until the wireless communication section 110 actually transmits the first signal (T1ₛ) after the control section 130 of the in-vehicle equipment 100 outputs to the wireless communication section 210 the instruction to start transmission of the first signal. In this case, after standing by for the time length specified by the specified value after the above instruction is output, the wireless communication section 110 transmits the first signal. In this case, it is possible to eliminate variations of the time length taken until the first signal is actually transmitted after the instruction is output, and realize an efficient and highly precise distance measurement process.

Furthermore, the above specified value may specify a time length taken until the control section 230 starts processing the first signal after the wireless communication section 210 of the portable device 200 receives the first signal (T1ᵣ). In this case, after standing by for the time length specified by the specified value after the wireless communication section 210 receives the first signal, the control section 230 starts processing the first signal. Furthermore, the control section 130 or the control section 230 (that is simply referred to as a control section when distinction therebetween is unnecessary) that controls the distance measurement process may calculate the distance measurement value by using as the propagation time of the first signal between the in-vehicle equipment 100 and the portable device 200 a time length obtained by subtracting the time length associated with the specified value from the time length taken until the portable device 200 starts processing the first signal after the in-vehicle equipment 100 transmits the first signal. According to this control, it is possible to eliminate variations of the time length taken until processing the first signal is actually started after the first signal is received, and realize the efficient and highly precise distance measurement process.

Furthermore, the above specified value may specify the time length (ΔT2) taken until the portable device 200 transmits the second signal after receiving the first signal. In this case, the control section according to the present embodiment causes the portable device 200 to transmit the second signal after the time length associated with the above specified value passes after the portable device 200 receives the first signal. Furthermore, in this case, the control section according to the present embodiment calculates the distance measurement value by using as the time information the time length taken for transmission and reception of the first signal and the second signal. More precisely, the control section may calculate the distance measurement value by using a time length obtained by subtracting the time length associated with the above specified value from the time length required to transmit and receive the first signal and the second signal, and dividing a subtraction result by 2 as the propagation time of the first signal and the second signal between the in-vehicle equipment 100 and the portable device 200.

In this regard, in a case where the above specified value is shared between the in-vehicle equipment 100 and the portable device 200 in advance, the time length (ΔT2) taken until the portable device 200 transmits the second signal after receiving the first signal does not need to be included in the second signal, that is, it is not necessary to transmit and receive the time information related to ΔT1 and ΔT2. Consequently, it is possible to effectively reduce a data amount to be transmitted and received, and prevent a decrease in reception sensitivity accompanying an increase in the data amount. Furthermore, according to the above-described process, it is not necessary to perform an encryption process and a decoding process of a signal including time information to secure security, and prevent an increase in a process time and a decrease in responsiveness.

### Supplementary Explanation

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

For example, the above embodiment has described as the example the case where the in-vehicle equipment 100 transmits the first signal, and the portable device 200 transmits the second signal as the response to the first signal. However, the present invention is not limited to this example. Roles of the in-vehicle equipment 100 and the portable device 200 may be reverse, or the roles may be dynamically switched. Furthermore, pieces of the in-vehicle equipment 100 or the portable devices 200 may perform the distance measurement process.

In addition, for example, the above embodiment has described the example where the present invention is applied to the smart entry system. However, the present invention is not limited to this example. The present invention can be applied to an arbitrary system that performs the distance measurement process by transmitting and receiving signals. The present invention is applicable to distance measurement processes of, for example, portable devices, vehicles, drones, buildings, and home appliances.

In addition, for example, the above embodiment has described the example where the wireless communication standards and the UWB are used. However, the present invention is not limited to this example. For example, Wi-Fi (registered trademark) and Bluetooth (registered trademark) may be used as the wireless communication standards.

Note that a series of processes of each device described in this description may be realized by using one of software, hardware, and a combination of the software and the hardware. Programs that configure the software are stored in advance in, for example, a recording medium (non-transitory media) provided inside or outside each device. Furthermore, each program is read on an RAM when, for example, executed by a computer, and is executed by a processor such as a CPU. The above recording medium is, for example, a magnetic disk, an optical disk, a magneto-optical disk, or a flash memory. Furthermore, the above computer programs may be distributed via, for example, a network without using the recording medium.

Furthermore, the process described using the sequence diagram in this description may not be necessarily executed in illustrated order. Some process steps may be executed in parallel. Furthermore, additional process steps may be adopted, or part of process steps may be omitted.

### REFERENCE SIGNS LIST

1: system
100: in-vehicle equipment
110: wireless communication section
120: storage section
130: control section
200: portable device
210: wireless communication section
220: storage section
230: control section

1. A control device comprising a control section configured to control a distance measurement process of calculating a distance measurement value that is a measurement value of a distance between communication devices,
wherein the control section calculates the distance measurement value based on at least time information that is information related to a time taken for transmission and reception of a signal between the communication devices.

2. The control device according to claim 1,
wherein the control section executes a process as the distance measurement process, the process including at least transmitting a first signal from one communication device to an other communication device, receiving the first signal at the other communication device, and calculating the distance measurement value by using as the time information a time length taken for the transmission and the reception of the first signal.

3. The control device according to claim 1,
wherein the control section causes one communication device to transmit a first signal to an other communication device, and
calculates the distance measurement value by using as the time information a specified specified value in addition to a time length taken for the transmission and reception of the first signal.

4. The control device according to claim 3, wherein the control section uses as the specified value a time length taken until the first signal is transmitted after an instruction to start the transmission of the first signal is output.

5. The control device according to claim 3,
wherein the control section uses as the specified value a time length taken until processing the first signal is started after the first signal is received.

6. The control device according to claim 5,
wherein the control section calculates the distance measurement value by using a time length as a propagation time of the first signal between the one communication device and the other communication device, the time length being obtained by subtracting a time length associated with the specified value from a time length taken until the other communication device starts processing the first signal after the one communication device transmits the first signal.

7. The control device according to claim 3, wherein
the control section includes transmitting the first signal from the one communication device to the other communication device, and transmitting a second signal as a response to the first signal from the other communication device to the one communication device, and calculating the distance measurement value by using as the time information a time length taken for transmission and reception of the first signal and the second signal, and
the control section calculates the distance measurement value by using as the specified value a time length taken until the other communication device transmits the second signal after receiving the first signal.

8. The control device according to claim 7,
wherein the control section causes the other communication device to transmit the second signal after a time length associated with the specified value passes after the other communication device receives the first signal.

9. The control device according to claim 7,
wherein the second signal does not include information related to the time length taken until the other communication device transmits the second signal after receiving the first signal.

10. The control device according to claim 7,
wherein the control section calculates the distance measurement value by using a time length as a propagation time of the first signal and the second signal between the one communication device and the other communication device, the time length being obtained by subtracting a time length associated with the specified value from a time length taken until the one communication device receives the second signal after transmitting the first signal, and dividing a subtraction result by 2.

11. The control device according to claim 7,
wherein the first signal and the second signal are signals that conform to ultra-wide band wireless communication standards.

12. The control device according to claim 2, wherein
the one communication device is mounted on a vehicle, and
the other communication device is carried by a user of the vehicle.

13. A non-transitory computer readable storage medium having a program stored therein, the program causing a computer to function as a control section configured to control a distance measurement process of calculating a distance measurement value that is a measurement value of a distance between communication devices,
wherein the program causes the control section to calculate the distance measurement value based on at least time information that is information related to a time taken for transmission and reception of a signal between the communication devices.
